(19) United States
(12) Patent Application Publication
(10) Pub. No.: US 2026/0182538 A1
(43) Pub. Date: Jul. 2, 2026

(54) FEEDING SYSTEM AND METHOD FOR FEEDING ANIMALS, AND, IN COMBINATION, AN ANIMAL SHED FOR KEEPING ANIMALS AND SUCH A FEEDING SYSTEM

(71) Applicant: LELY PATENT N.V., Maassluis (NL)

(72) Inventors: Tomas Robert WIGMAN, Maassluis (NL); Tom Adrianus Josephus VAN DE VEN, Maassluis (NL); Vincenzo FERRANTI, Maassluis (NL)

(73) Assignee: LELY PATENT N.V., Maassluis (NL)

(21) Appl. No.: 19/130,230

(22) PCT Filed: Dec. 14, 2023
(86) PCT No.: PCT/IB2023/062686

§ 371 Date: May 15, 2025

(30) Foreign Application Priority Data
Dec. 19, 2022 (NL) 2033749

(51) Int. Cl. A01K 5/02; A01K 5/00

(52) U.S. Cl. CPC A01K 5/0266; A01K 5/001; A01K 5/0275

(57) ABSTRACT

A feeding system for feeding animals, such as cows, comprises an autonomous feeding device with a container for receiving a batch of feed. The container has a maximum feed load. A feed-quantity measuring device measures the quantity of feed that is available for consumption by the animals at the feeding places. A control system first determines which feeding places have a feed requirement on the basis of a feeding criterion and the measured quantity of feed at the feeding places. The control system provides a combined feeding task list of one or more feeding tasks to be carried out by the feeding device with a batch of feed received in the container. Each feeding task comprises a quantity of feed to be dispensed for a feeding place. The control system begins with a first feeding task for a first feeding place with a feed requirement. The control system then adds one or more further feeding tasks for further feeding places with a feed requirement to the combined feeding task list without the maximum feed load being exceeded. If at least one additional feeding task for an additional feeding place with a feed requirement then exceeds the maximum feed load, the control system adds this additional feeding task to the combined feeding task list if this prevents a small batch of feed being produced in a subsequent feeding run. In this case, the quantities of feed of the combined feeding task list are reduced such that they fit in the container of the feeding device.

The invention relates to a feeding system for feeding animals, in particular cows, such as dairy cows or beef cows.

WO 2015/178763 A1 discloses a feeding system for feeding animals. This feeding system comprises an autonomous feeding device with a container for receiving a batch of feed. The container has a maximum feed load, i.e. the maximum weight of feed (kg) that can be received in the container. The feeding device is configured to move autonomously to feed fences in order to bring feed received in the container to the feed fences and dispense it there.

The autonomous feeding device provides feed not according to a fixed timetable, but in a demand-driven manner. The feeding device comprises a control system and a feed height meter for measuring the height of the feed at the feed fences. The measured feed heights are a measure for the quantity of feed that is still available for consumption by the animals at the feeding places. On the basis of the measured feed heights at the different feed fences, the control system determines which of these feed fences will have feed dispensed to them, i.e. which feed fences have a feed requirement. The control system generates a list of feed fences with a feed requirement, wherein a priority is assigned to each feed fence with a feed requirement.

The control system then determines the quantity of feed for loading into the container of the autonomous feeding device and how that feed will be distributed among one or more of the feed fences with a feed requirement. The control system begins with determining the quantity of feed intended for the feed fence with the highest priority. The control system then determines whether further feed fences can be combined in order of decreasing priority, i.e. whether the quantities of feed which are determined for these feed fences can be added, the maximum feed load being taken into account.

In this known feeding system, it is possible that the control system stops selecting further feed fences when the sum of the quantities of feed for the feed fences becomes greater than the maximum feed load of the container. The control system will then proportionately lower the weight of the quantities of feed for the feed fences, in such a way that the reduced quantities of feed fit in the container of the feeding device. If, for example, the quantity of feed for the feed fence with the highest priority is 200 kg and the quantity of feed for the feed fence with the second-highest priority is 500 kg, whilst the maximum feed load is 600 kg, the autonomous feeding device will provide feed solely to these two feed fences. The autonomous feeding device provides (200/700)*600=171 kg of feed at the feed fence with the highest priority and (500/700)*600=429 kg of feed at the feed fence with the second-highest priority.

Instead of stopping with the selection of further feed fences when the maximum feed load is exceeded, it is also possible in this known feeding system that the control system continues adding further feed fences. In this case, the control system will also proportionately lower the weight of the quantities of feed for the feed fences, in such a way that the reduced quantities of feed collectively are not greater than the maximum feed load. In other words, the maximum quantity of feed that can be received in the container will then be distributed among more and more feed fences, as a result of which the quantity of feed for each feed fence decreases. In this case, for example, the control system stops selecting further feed fences if the addition of a further feed fence would result in a reduced quantity of feed that is smaller than a limit value for a minimum quantity of feed at one of the feed fences. If the quantity of feed to be metered out at a feed fence is too small, the feed can for example no longer be distributed uniformly over the length of the feed fence.

The demand-driven feeding according to the known feeding system described above has significant advantages. In feeding, the farmer seeks a compromise between ensuring that the animals are always able to eat and maintaining the quality of the feed, in particular the freshness. In the case of dairy cows, it is important for the milk production and health of the dairy cows that feed is always available at the feeding places. It is also important in the case of other animals, such as beef cows, that the animals are always able to eat. However, if a large quantity of feed is dispensed in one go at the feeding places and the feed remains for a relatively long period of time, the quality of the feed decreases, for example as a result of rotting. With demand-driven feeding, it is possible to deposit relatively little feed at the feeding places, such that the quality of the feed is ensured, and at the same time to provide feed in a timely manner to prevent the feed for the animals from running out.

However, sometimes the control system of the known feeding system described above determines that only a small quantity of feed has to be dispensed to one or more feeding places. During the day, it may happen multiple times that the autonomous feeding device travels with only a small batch of feed, i.e. the capacity of the container is not optimally utilized. This has a negative influence on the capacity of the demand-driven feeding system during the day.

It is an object of the invention to provide an improved demand-driven feeding system comprising an autonomous feeding device for feeding animals, wherein in particular the capacity of the feeding system during the day is increased.

This object is achieved according to the invention by means of a feeding system for feeding animals, in particular cows, such as dairy cows or beef cows, at a plurality of feeding places, wherein the feeding system comprises:
at least one feeding device with a container for receiving a batch of feed, which container has a maximum feed load, and which feeding device is configured to move autonomously to the feeding places in order to bring feed received in the container to the feeding places and dispense it there,
a feed-quantity measuring device for measuring the quantity of feed that is available for consumption by the animals at the feeding places, and
a control system which is configured and/or programmed to provide a combined feeding task list of one or more feeding tasks to be carried out by the feeding device with a batch of feed received in the container, wherein each feeding task comprises a quantity of feed to be dispensed for one of the feeding places, and wherein this provision of the combined feeding task list comprises:
   determining which feeding places have a feed requirement, in particular a feed requirement greater than 0, on the basis of a feeding criterion and the quantity of feed measured by the feed-quantity measuring device at the feeding places,
   selecting a first feeding place from the feeding places with a feed requirement,
   determining a first feeding task comprising a first quantity of feed determined for the first feeding place, and adding the first feeding task to the combined feeding task list,
   determining one or more further feeding tasks each comprising a further quantity of feed determined for a further feeding place selected from the feeding places with a feed requirement, and adding the one or more further feeding tasks to the combined feeding task list if these one or more further quantities of feed are able to be added to the first quantity of feed without the maximum feed load of the container being exceeded,
   determining at least one additional feeding task comprising an additional quantity of feed determined for an additional feeding place selected from the feeding places with a feed requirement, wherein this additional quantity of feed added to the first and one or more further quantities of feed of the feeding tasks on the combined feeding task list exceeds the maximum feed load of the container, and adding this additional feeding task to the combined feeding task list if
      i. a first sum S1 of the quantities of feed which are determined for all the feeding places with a feed requirement minus an overload value O, which is equal to the maximum feed load and a limit value for a small quantity of feed added together, is greater than this limit value or is smaller than 0, and
      ii. a second sum S2 of the first and one or more further quantities of feed of the feeding tasks on the combined feeding task list and this additional quantity of feed is smaller than this overload value O,
   wherein, in the event that this additional feeding task is added to the combined feeding task list, the control system reduces at least one of the first quantity of feed, the one or more further quantities of feed and this additional quantity of feed in such a way that a reduced sum of the first quantity of feed, the one or more further quantities of feed and this additional quantity of feed is smaller than or equal to the maximum feed load.

The feeding system according to the invention works in a demand-driven manner. The feed-quantity measuring device repeatedly measures, for example with intervals or continuously, the quantity of feed that is available for consumption by the animals at the feeding places. On the basis of a feeding criterion and the measured quantity of feed at the feeding places, the control system determines a feed requirement of each of the feeding places, i.e. the control system determines which feeding places have a feed requirement. The control system generates, for example, a list of feeding places with a feed requirement. The feeding places which have a feed requirement are eligible to be provided with feed.

The control system then provides, i.e. generates or determines, a combined feeding task list of one or more feeding tasks to be carried out by the feeding device with a batch of feed to be loaded into the container. Each feeding task comprises a quantity of feed (kg) to be dispensed for one of the feeding places. By way of example, for each feeding place, a respective value for a quantity of feed to be dispensed is stored in a memory of the control system. In other words, the control system comprises a memory in which, for each feeding place, a respective value that is representative of the quantity of feed to be dispensed when this feeding place has a feed requirement is stored and/or recorded, for example a value in kg. This value for each individual feeding place can, for example, be manually input by a user, in particular in dependence on the group of animals fed at this feeding place. If a feeding place has a feed requirement, the control system uses these values when determining the feeding tasks.

In order to determine a first feeding task, the control system selects a first feeding place from the list of feeding places with a feed requirement. The control system determines a first quantity of feed to be dispensed at this first feeding place, in particular by retrieving the value associated with the first feeding place from the memory. The first feeding task is then established.

The control system then determines whether one or more further feeding tasks fit with the first feeding task in the container of the feeding device by checking which further quantities of feed are required at the further feeding places from the list of feeding places with a feed requirement. The control system analyses whether one or more of these further quantities of feed can be added to the first quantity of feed without the maximum feed load of the container being exceeded. The maximum feed load is in particular a maximum weight of feed (kg) that can be received in the container. The control system adds as many further quantities of feed as possible to the first quantity of feed. Each further feeding task comprises such an added, further quantity of feed intended for an associated further feeding place.

After all the possible further quantities of feed have been added without the maximum feed load being exceeded, it happens in practice that one or more small feeding tasks remain in the list of feeding places with a feed requirement, i.e. there are one or more feeding places with a feed requirement for only a small quantity of feed which, however, no longer fits in the container. If such small feeding tasks are carried out by the feeding device only in a subsequent feeding run, there is the risk that the feeding device then travels with only a small batch of feed.

Therefore, according to the invention, after all the possible further quantities of feed have been added without the maximum feed load being exceeded, analysis is then also performed as to whether it is possible for one or more small feeding tasks to be added. If the control system determines that in the list of feeding places with a feed requirement there is still at least one additional feeding place that can be supplemented with an additional quantity of feed, the control system adds an additional feeding task to the combined feeding task list if two conditions i and ii are met.

The first condition i is that a first sum of the quantities of feed which are determined for all the feeding places with a feed requirement minus an overload value, which is equal to the maximum feed load and a limit value for a small quantity of feed added together (S1-O), is greater than this limit value or is smaller than 0. With this condition, the control system checks whether, in the feeding task list, for a subsequent feeding run, only one small feeding task remains or only a plurality of feeding tasks that collectively are still small remain.

If this is the case, the control system analyses whether the second condition ii is met that a second sum of the first and one or more further quantities of feed of the feeding tasks on the combined feeding task list and this additional quantity of feed collectively is smaller than this overload value (S2 smaller than O). In this way, the control system checks whether the additional quantity of feed is suitable to be added, i.e. is in itself not already too great.

If the control system determines that both conditions i and ii are met, the additional feeding task will be added to the combined feeding task list. Since the total of the quantities of feed of all the feeding tasks collectively cannot be greater than the maximum feed load of the container, the control system is also configured to, in the event that this additional feeding task is added to the combined feeding task list, reduce the first quantity of feed and/or the one or more further quantities of feed and/or the additional quantity of feed in such a way that the sum of the first quantity of feed, the one or more further quantities of feed and the small additional quantity of feed is smaller than or equal to the maximum feed load.

In this way, it no longer or hardly happens in practice that small feeding tasks remain for a subsequent feeding run. In other words, the demand-driven autonomous feeding device will not dispense any small batches of feed, such that the capacity of the container is better utilized and the capacity of the demand-driven feeding system according to the invention is greater during the day.

Moreover, it is possible according to the invention for the control system to be configured to, if an additional feeding task is added to the combined feeding task list, subsequently also determine for a second additional feeding task whether the aforementioned conditions i and ii are met. In this case, after adding a first small feeding task, the control system checks whether it is possible to add a second small feeding task. It is of course possible according to the invention for the control system to be configured to, if a second additional feeding task is added to the combined feeding task list, again analyse whether a third small additional feeding task can be added, and so on. This makes it possible to ensure that, wherever possible, all the small feeding tasks are taken and then do not remain in the list of feeding places with a feed requirement for a subsequent feeding run.

In a preferred embodiment, the control system is configured to not add the additional feeding task to the combined feeding task list if the first sum of the quantities of feed which are determined for all the feeding places with a feed requirement minus the overload value (S1-O) is smaller than the limit value and is greater than 0. In this case, the additional feeding task remains for a subsequent feeding run. However, since this additional feeding task does not meet condition i, this feeding task is not small, and therefore it is ensured that the batch of feed for the subsequent feeding run is large enough to use the capacity of the feeding system efficiently.

It is also preferred according to the invention that the control system is configured to not add the additional feeding task to the combined feeding task list if the second sum of the first and one or more further quantities of feed of the feeding tasks on the combined feeding task list and this additional quantity of feed is greater than the overload value (S2 greater than O). In this case, the additional feeding task also remains for a subsequent feeding run. Since this additional feeding task does not meet condition ii, this feeding task is not suitable to be added because this additional quantity of feed no longer fits in the container of the feeding device.

In an embodiment according to the invention, the predetermined limit value is settable. In particular, the predetermined limit value can be input into the control system by a user. It is preferred according to the invention that the predetermined limit value is correlated with the maximum feed load of the container. The predetermined limit value is selected, such as by a user, in dependence on the maximum feed load of the container. The predetermined limit value preferably lies between 10% and 50% of the maximum feed load of the container, in particular between 20% and 40%. The limit value is in particular 30% of the maximum feed load of the container. With such limit values, it is surprisingly achieved that the feeding system according to the invention almost always circulates with a well-stocked container, such that the capacity of the feeding system is optimal.

It is noted that WO 2013/095281 A1 discloses a feeding system for feeding animals with mixed feed according to different recipes. This feeding system comprises a feed mixing device for mixing batches of feed according to selected recipes, and a feed distribution system for distributing the batches of mixed feed among different groups of animals. If a group consists of only a few animals, for example sick animals, only a small batch of feed compared with the maximum load capacity of the feed mixer would have to be mixed. The feed mixer then does not cut and mix satisfactorily. The accuracy when loading small quantities of ingredients is also insufficient, such that the feed composition is not optimal. When only a small batch according to a first recipe is necessary, the feed mixer in this feeding system is therefore still loaded with a large batch according to that first recipe. The required small batch is dispensed to the animals, and the remaining quantity of mixed feed according to the first recipe is then used to make a subsequent batch of mixed feed according to a second recipe and fed to another group of animals. In other words, ingredients are admixed with the remaining quantity of mixed feed to obtain a batch of mixed feed according to the second recipe. This feeding system is complicated and does not relate to demand-driven feeding.

The feeding system according to the invention is preferably configured to feed animals with mixed feed. In a preferred embodiment according to the invention, the control system comprises a memory in which different recipes for mixed feed are stored, wherein each recipe comprises one or more ingredients in a predetermined ratio, and wherein the control system is configured to determine, for at least each feeding place with a feed requirement, the associated recipe for mixed feed, for example by retrieving the associated recipe from the memory, and wherein the control system is configured to, after selecting the first feeding place with a feed requirement for mixed feed according to a first recipe and determining the first feeding task for the first feeding place, when determining the further and additional feeding tasks, only select feeding places with a feed requirement for mixed feed according to the same first recipe. The first quantity of feed and the further and additional quantities of feed comprise the ingredients according to the first recipe, i.e. the recipe associated with the first feeding place.

During feeding with mixed feed according to a prescribed recipe, i.e. with ingredients in a predetermined ratio, it is particularly important that the mixed feed actually dispensed corresponds accurately to the prescribed recipe. Since the feeding system according to the invention prevents feeding tasks of small batches of feed, the quantities (kg) of the different ingredients can be loaded more accurately according to the prescribed recipe, and the differences between the prescribed recipe and the mixed feed that is actually dispensed are minimal. This is particularly favourable for the health of the animals, the production of milk or meat, and the management of the feed supplies.

In an embodiment according to the invention, for each feeding place, a respective value for a quantity of feed to be dispensed is stored in the control system. In other words, the control system comprises a memory in which, for each feeding place, a respective value that is representative of the quantity of feed to be dispensed when this feeding place has a feed requirement is stored and/or recorded, for example a value in kg. This value for each individual feeding place can, for example, be manually input by a user, in particular in dependence on the group of animals fed at this feeding place. If a feeding place has a feed requirement, the control system therefore uses these values when determining the feeding tasks according to the invention.

In particular, when determining the feeding tasks, the control system sets the first quantity of feed for the first feeding place, the one or more further quantities of feed for the further feeding places and the one or more additional quantities of feed for the additional feeding places equal to the values recorded in the memory for the quantity of feed to be dispensed for these feeding places. However, it is also possible that the control system is configured to check the values manually input by the user for each feeding place and possibly adapt them on the basis of data that are available for this feeding place in the memory of the control system, such as the dimensions of the feeding place, the number of animals fed at the feeding place and required nutritional values of these animals, for example in dependence on the lactation stage in the feeding of dairy animals. In addition, the control system may be configured to calculate the quantity of feed for each feeding place on the basis of the feed requirement of this feeding place. In this case, there is for example no manual input by the user, rather the control system automatically determines the quantities of feed to be dispensed, in particular on the basis of the feed requirement.

It is possible according to the invention that the maximum feed load of the container is settable, in particular can be input into the control system by a user. If the feeding system according to the invention is for example used for feeding with mixed feed, the maximum feed load may be dependent on the first recipe associated with the selected first feeding place. In this case, it is possible that, for each recipe, an associated maximum feed load is input into the memory of the control system by the user. The control system is configured to determine, in particular retrieve from the memory, the maximum feed load of the container during operation after the first feeding place has been selected and the associated first recipe has been determined. Moreover, the maximum feed load may also be settable when feeding with only one feed type, for example if a transfer to another feed type is performed or the composition of the feed type changes over time.

The control system can determine whether the feeding places have a feed requirement in different ways.

In an embodiment according to the invention, the feeding criterion comprises a threshold value for the quantity of available feed at the feeding places, wherein the control system is configured to determine the feed requirement of the feeding places by comparing the quantity of feed measured by the feed-quantity measuring device at the feeding places with this threshold value for the quantity of available feed. For each feeding place, the control system determines whether the measured quantity of feed at this feeding place has dropped below the threshold value for the quantity of available feed. If that is the case, this feeding place has a feed requirement, in particular a feed requirement greater than 0. As described above, fixed values for the quantity of feed to be dispensed for each individual feeding place can be set in the control system. However, it is also possible that the control system determines how large the quantity of feed to be dispensed for each individual feeding place is on the basis of the difference between the measured quantity of feed and the threshold value for the quantity of available feed.

Preferably, the threshold value for the quantity of available feed is set in such a way that the feeding device dispenses feed at each feeding place before the animals have eaten the feed at this feeding place. The feeding criterion is such that in each case feed is provided before the feed at one of the feeding places runs out. In other words, the feeding system according to the invention normally ensures that feed is available at the feeding places and the animals are virtually always able to eat.

In an alternative embodiment, in order to determine the feed requirement, the control system is configured to store quantities of feed measured at different points in time by the feed-quantity measuring device at the feeding places as feed-quantity values in a memory, and to use these stored feed-quantity values as a basis to calculate, i.e. predict, the progression of the feed-quantity values over time after the first point in time, in particular by means of a self-learning algorithm, wherein the control system is configured to use the calculated progression when determining the feed requirement of the feeding places. By, for example, determining when the feed at the feeding places runs out and subsequently extrapolating how much time is required to prepare the feed in the container of the feeding device and/or a stationary (pre-)mixer and how long it takes to bring the feed loaded into the container to the feeding places, the control system can also determine a feed requirement of the feeding places in this manner.

In this case, it is also preferred that the animals are always able to eat. The control system is in particular configured to determine a feed requirement of the feeding places on the basis of the calculated progression in such a way that the feeding device dispenses feed at each feeding place before the animals have eaten the feed at this feeding place.

In an embodiment, the control system is configured to determine which feeding place with a feed requirement has the highest priority, for example by determining the feeding place at which the quantity of feed measured by the feed-quantity measuring device has dropped furthest below the threshold value for the quantity of available food or by determining the feeding place at which the feed is predicted to run out first. The control system can then select this feeding place as the first feeding place. In this case, the first feeding place is the feeding place with the highest priority to be provided with feed, in particular the feeding place with the greatest difference between the measured remaining quantity of feed and the threshold value or the feeding place for which it is predicted that the feed at this feeding place will run out first. The feeding system according to the invention takes this feeding place as a starting point for the next feeding task.

It is also possible according to the invention that the control system is configured to determine a priority for each feeding place with a feed requirement, and to determine the one or more further feeding tasks and/or the one or more additional feeding tasks and/or to add them to the combined feeding task list in order of decreasing priority of the feeding places with a feed requirement. When determining the one or more further feeding tasks and/or adding the one or more further feeding tasks to the combined feeding task list, i.e. when adding the one or more further quantities of feed for further feeding places to the first quantity of feed for the feeding place with the highest priority, without the maximum feed load of the container being exceeded, the control system first analyses the feeding place with the second-highest priority, then the feeding place with the third-highest priority, and so on. When determining the one or more small additional feeding tasks and/or adding the one or more small additional feeding tasks to the combined feeding task list, the control system also determines whether the conditions i and ii are met in order of decreasing priority.

The feeding places that would need to be supplemented first with fresh feed are provided with feed in the next feeding run of the autonomous feeding device. In this way, the risk is minimal that one or more of the feeding places are depleted, or at least an empty feeding place is supplemented with feed as quickly as possible, such that the animals are essentially always able to eat. “Empty” should be understood to mean that the feeding places are effectively empty, i.e. if there is still a residual quantity of feed that is essentially no longer suitable for consumption by the animals or is in practice no longer eaten by the animals, the feeding place is “empty”. The feed is then “depleted”, even if there is still a low residual quantity of feed.

In an embodiment, the feeding system is configured to feed animals with feed from a feed supply, and the feeding system comprises a feed loading system for loading feed from the feed supply into the container of the feeding device. The feed loading system can be configured in different ways according to the invention. The feed loading system can load feed, in particular different ingredients or feed types, from the feed supply into the container of the autonomous feeding device. In this case, it is possible that the container of the autonomous feeding device comprises a mixing device for mixing the quantity of feed loaded into the container. The mixing device mixes the loaded feed to form a mixed batch of feed. The autonomous feeding device then brings the mixed batch of feed to the one or more feeding places. In this case, the autonomous feeding device forms a mixing and feeding device.

However, it is also possible according to the invention that the feed loading system comprises a stationary mixing device for mixing feed. The stationary mixing device is, for example, configured to receive a quantity of feed that corresponds to a batch of feed for the container of the autonomous feeding device. In this case, the feed loading system is configured to load feed from the feed supply into the stationary mixing device, and to load the mixed feed from the stationary mixing device into the container of the autonomous feeding device in order for a mixed batch of feed to be received therein. The autonomous feeding device then transports the mixed batch of feed to the feeding places. In this case, the feeding device does not simultaneously form the mixing device—the feeding device is only configured to meter out the feed.

In addition, a combination is possible, i.e. that, as described above, the autonomous feeding device comprises a mixing device, i.e. is configured as an autonomous mixing and feeding device, and a stationary mixer is also used to mix and/or cut the feed before the feed is transferred to the container of the feeding device. The pre-mixed and/or pre-cut feed is then more quickly ready to be metered out by the feeding device.

The feeding places according to the invention can also be configured in different ways. It is preferred that the or each feeding place comprises at least one feed fence for feeding the animals, such as in an animal shed, wherein the feeding device is configured to autonomously move a batch of feed, received in the container, from the feed supply to the feed fence and to autonomously dispense and/or meter that feed along the feed fence. Here, a single feed fence construction in the animal shed may correspond to a plurality of feed fences in the control system, i.e. if various mutually separate groups of animals are kept along a single feed fence construction in the animal shed, each portion of the feed fence construction that is associated with a group of animals is defined as a feed fence in the control system. The feeding places or feed fences are each coupled to a group of animals.

The feed-quantity measuring device can also be configured in different ways. In a preferred embodiment, the feed-quantity measuring device is fitted to the feeding device, wherein the feed-quantity measuring device is configured to measure the quantity of feed that is available for consumption by the animals at the or each feeding place as the feeding device moves along this feeding place. The feeding device preferably further comprises a feed pushing device for pushing feed in a direction transverse to the movement direction or direction of travel of the feeding device. By way of example, the feed pushing device is configured to push feed that lies along a feeding place and that has been moved away from the feeding place by the animals whilst eating back towards the feeding place.

It is also possible according to the invention that the container of the autonomous feeding device comprises a dispensing device for dispensing feed from the container. With respect to the dispensing device, the feed-quantity measuring device can be fitted to the autonomous feeding device in such a way that the quantity of feed just dispensed by the dispensing device is included in the measurement of the quantity of feed that is available for consumption by the animals at the feeding places. In other words, the quantity of feed that is metered out by the autonomous feeding device is immediately included in the measurement of the quantity of feed that is available for consumption by the animals at the or each feeding place. In this case, the feed pushing device may be configured to push feed that is dispensed by the autonomous feeding device. In other words, when the feed from the container of the autonomous feeding device is dispensed, that feed is immediately pushed. The feed-quantity measuring device then measures the pushed feed, which comprises both feed that is already present at the feeding place and freshly metered-out feed.

In an alternative embodiment, the feed-quantity measuring device comprises, for example, one or more cameras which are configured to capture images of the feed at the feeding places, wherein the control system is configured to determine the quantity of feed that is available for consumption by the animals at the feeding places on the basis of the images from the camera, in particular with the aid of image recognition. In this case, it is possible that one or more of the cameras are fitted in an animal shed for the keeping of the animals. Instead thereof or in addition thereto, the one or more cameras may be fitted to the autonomous feeding device. By means of camera images and image recognition techniques, it is also possible to accurately measure the quantity of feed at the feeding places.

The feeding device of the feeding system according to the invention can also be configured in different ways. The autonomous feeding device is preferably configured as a self-propelled feed carriage with wheels. The feed carriage is then movable over a floor, yard of a farm or another ground surface by means of the wheels. In this way, the feeding system according to the invention can be used in farms in a relatively simple and cost-effective manner. However, the autonomous feeding device may also be suspended from a rail, along which the feeding device is able to autonomously move to the feeding places. In this case, fitting the rail at the farm will entail additional costs. It is of course possible according to the invention that the feeding system comprises more than one autonomous feeding device, in particular two autonomous feeding devices.

The invention also relates, in combination, to an animal shed for keeping animals, such as dairy cows or beef cows, and a feeding system as described above.

The invention also relates to a method for feeding animals, in particular cows, such as dairy cows or beef cows, at a plurality of feeding places with feed from a feed supply, wherein use is made of a feeding system as described above.

The method according to the invention has the same technical effects and advantages as described above in relation to the system according to the invention.

The invention will now be explained in more detail with reference to the accompanying figures.

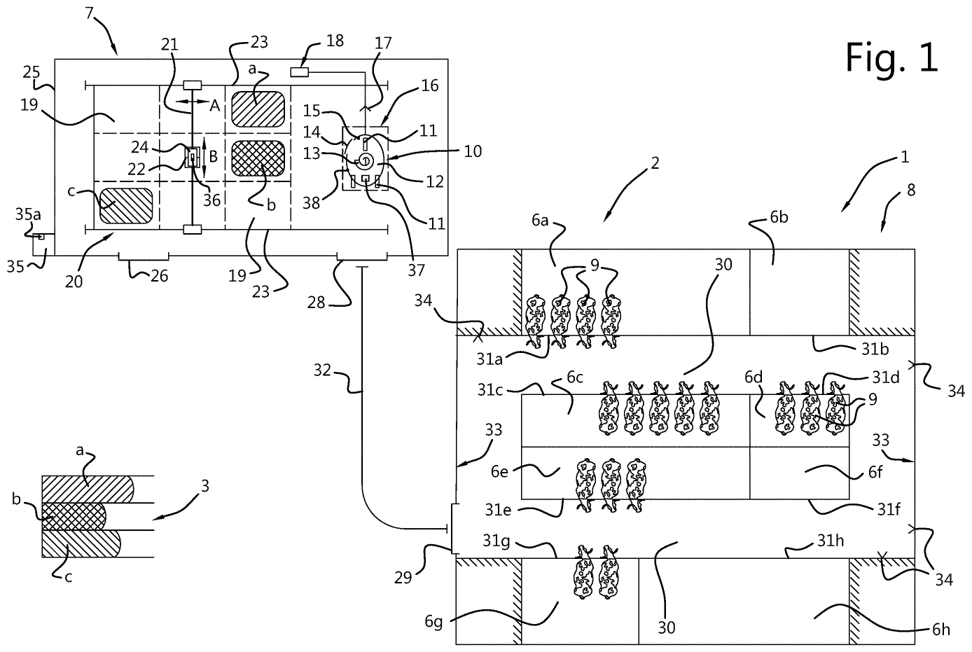

FIG. 1 shows a diagrammatic top view of a feeding system according to the invention.

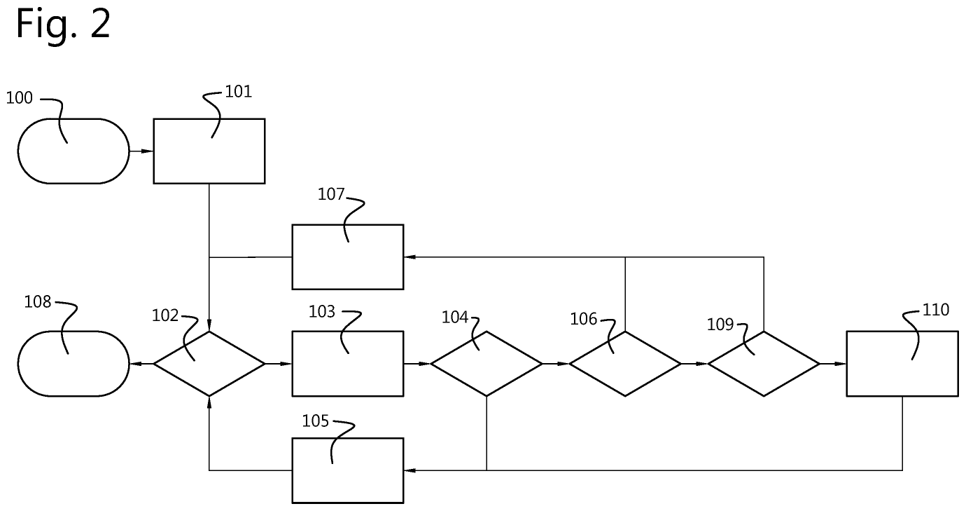

FIG. 2 shows a flow chart illustrating the steps for determining the feeding tasks according to the invention.

The feeding system for feeding animals, in particular cows, such as dairy cows or beef cows, is denoted as a whole by reference numeral 1 in FIG. 1. The feeding system 1 is arranged in an operational area 2. The feeding system 1 comprises a feed store 3 containing a plurality of feed types a, b, c, a feed supply 7 containing the same feed types a, b, c in this exemplary embodiment, an animal shed 8 containing the animals 9, and an autonomous feeding device 10 for feeding the animals 9 with feed from the feed supply 7. Although the feed store 3 illustrated diagrammatically in FIG. 1 comprises three adjacent silos containing feed types a, b, c, for example silage, the feed store 3 may comprise further storage devices and/or feed types, such as tower silos containing bulk feed, for example corn, potatoes and/or beets, or pressed bales. In the same way, the feed supply 7 may also contain more than the three feed types a, b, c shown in FIG. 1, such as concentrate. Obviously, the operational area 2 may contain a plurality of animal sheds and optionally also a dwelling, one or more further animal sheds, barns and other buildings (not illustrated).

In this exemplary embodiment, the autonomous feeding device 10 for feeding the animals 9 is configured as a self-propelled feed carriage. It is of course possible according to the invention that the feeding system 1 comprises more than one autonomous feed carriage 10, in particular two autonomous feed carriages 10 (not illustrated). The feed carriage 10 is then movable over a floor, yard of a farm or another substrate by means of wheels 11. The feed carriage 10 comprises a container 12 for receiving a batch of feed. In this exemplary embodiment, a mixing device 13 for cutting and/or mixing feed is fitted in the container 12. The container 12 has a maximum feed load, i.e. a maximum weight of feed (kg) that can be received in the container 12. A dispensing device 14 is provided for dispensing and/or metering the feed out of the container 12. The dispensing device 14 comprises, for example, a door that is movable between a closed and open position.

The feed carriage 10 is autonomously movable by means of a drive and steer system for driving and steering the feed carriage 10 (not illustrated). The drive and steer system of the feed carriage 10 is controllable by a control unit 15 of the feed carriage 10. In this exemplary embodiment, the drive and steer system comprises a respective electric drive motor (not illustrated) for each rear wheel 11. The electric drive motors of the rear wheels 11 are controllable independently of each other. By controlling the rotational speed of the rear wheels 11, the feed carriage 10 is able to travel forwards or backwards in a straight line or make a turn.

The drive and steer system comprises a battery system for storing electrical energy (not illustrated). The battery system is connected to the electric drive motors. In FIG. 1, the feed carriage 10 is situated at a feed loading station 16, in which the container 12 of the feed carriage 10 is loaded with feed. The feed loading station 16 comprises a charging point 17 of a charging system 18 for charging the battery system of the feed carriage 10. The feed loading station 16 therefore also forms a charging station. The control unit 15 of the feed carriage 10 is configured to control the mixing device 13 in such a way that the mixing device 13 mixes the feed received in the container 12 while the feed carriage 10 is connected to the charging point 17 and the battery system of the feed carriage 10 is charged by means of the charging system 18.

In this exemplary embodiment, the feed supply 7 forms a feed kitchen, i.e. an interim feed store. The feed kitchen comprises a number of feed supply places 19 to accommodate the feed types a, b, c and optionally further feed types (not shown). The feed supply places 19 are separated from each other—the feed supply places 19 are, for example, formed by delineated spaces on a floor, on which a silage block or a pressed bale is situated. Also, one or more of the feed supply places 19 may comprise a trough for receiving bulk feed, such as corn, potatoes or beets. The capacity of the feed kitchen 7 is, for example, limited to a number of days. The quantities of feed of the feed types a, b, c which can be accommodated in the feed kitchen 7 are smaller than the quantities of feed of these feed types a, b, c which are stored in the feed store 3.

A feed loading system 20 is provided for transferring feed from the feed kitchen 7 to the container 12 of the feed carriage 10 when the feed carriage 10 is situated at the feed loading station 16. In this exemplary embodiment, the feed loading system 20 comprises a movable support rail 21 which is movably (see arrow A) arranged on two fixed support rails 23 which are arranged mutually parallel to and spaced apart from each other. The movable support rail 21 comprises a trolley 22 which is movable along said rail (see arrow B). The trolley 22 is provided with a vertically movable feed grab 24 to grab feed from the feed supply places 19. The feed grab 24 suspended from the trolley 22 can move in a substantially horizontal plane so as to be situated above each of the feed supply places 19.

The feeding system 1 according to the invention comprises a control system 35 comprising a memory 35a. Although the control system 35 is diagrammatically depicted on the left in FIG. 1, the control system 35 could also be arranged at another location. The memory 35a may be a storage means on a computer of the farm, a server at the manufacturer of the feeding system 1, said server being connected to the control system 35 via the Internet, and/or a cloud store and/or something else.

The feed grab 24 is controlled by the control system 35. Recipe data are stored in the memory 35a. The recipe data comprise, for example, a plurality of recipes for different groups of animals 9. A recipe is a ration. On the basis of the recipe data of a selected recipe, i.e. mixed feed of feed types in a desired ratio (kg), the feed grab 24 brings quantities of the feed types a, b, c from the feed supply places 19 to the container 12 of the feed carriage 10, while the feed carriage 10 is situated at the feed loading station 16, in such a way that the selected recipe is received in the container 12. By transferring a plurality of feed types to the container 12 of the feed carriage 10, a batch of mixed feed of feed types is produced therein according to the selected recipe and in a desired quantity that is dependent on the feed requirement, i.e. a batch of mixed feed (kg) of feed types in a desired ratio.

In other words, in order to compose the batch of feed, the feed grab 24 in each case takes a quantity of feed from one of the feed supply places 19, the feed grab 24 moves that feed across the feed supply places 19 until it is above the container 12 of the feed carriage 10 and then drops that feed into the container 12. The feed carriage 10 comprises a weighing device 37 which is configured to measure the weight (kg) of the feed that is received in the container 12. The weighing device 37 is connected to the control system 35. When loading a batch of feed into the container 12 of the feed carriage 10, the control system 35 monitors how much feed (kg) of each feed type a, b, c is loaded into the container 12.

Obviously, the feed supply 7 and the feed loading system 20 may also be configured differently. The feed grab 24 may, for example, also be incorporated in the feed carriage 10. In that case, the feed grab of the feed carriage 10 loads the container 12 with feed in the desired quantity and composition, in particular directly from the feed store 3. Furthermore, instead of or in addition to the feed supply places 19 shown in FIG. 1, the feeding system 1 may comprise one or more other feed supply devices, such as a driven conveyor belt for receiving pressed bales or blocks cut from a silo in combination with a releasing device for releasing feed from such a bale or block, for example a cutter or blade, in particular a so-called “bale shredder”, and/or a trough for bulk feed comprising an auger for the metered discharge of the feed, such as a so-called “commodity box”, and/or a tower silo and/or something else. Here, the feed loading system may be provided with one or more driven conveyor belts for moving the feed from the or each feed supply device to the container 12 of the feed carriage 10.

In addition, it is possible that the feed is not mixed and/or cut in the container 12 of the feed carriage 10, but in a stationary mixer arranged at the feed supply 7 (not illustrated). In that case, the feed grab 24 and/or other feed supply device loads a batch of feed from the feed supply system 7 into the stationary mixer. After the mixing and/or cutting by means of the stationary mixer, the mixed feed is then loaded into the feed carriage 10. It is then not necessary for a mixing device to be fitted in the container 12 of the feed carriage 10. Moreover, it is also possible that the feed is pre-mixed and pre-cut in a stationary mixer, and the feed carriage 10 still has a mixing device for further mixing and cutting of the feed.

The feed kitchen 7 is surrounded by a safety fence 25. An access door 26 is provided in the safety fence 25, such that, for example, a fork-lift truck or tractor can enter the feed kitchen 7 via the access door 26 in order to replenish the feed supply places 19 with the different feed types a, b, c from the feed store 3. In addition, the safety fence 25 comprises a passage door 28 for the feed carriage 10. The feed carriage 10 can enter and exit the feed kitchen 7 via the passage door 28. Obviously, it is possible that the safety fence 25 only comprises one door, whereby both the feed carriage 10 and the tractor or fork-lift truck can enter and exit the feed kitchen 7. Also, the safety fence 25 in FIG. 1 may extend to the left of the feed loading station 16 and the passage door 28, in which case the safety fence 25 protects the feed kitchen 7 containing the feed supply places 19, but the feed loading station 16 is freely accessible via the passage door 28 (not shown).

In addition to the safety fence 25, the feeding system 1 may comprise further safety features, for example an emergency stop by means of which the feed carriage 10 and/or the feed loading system 20 is stopped immediately. Here, for example, an alarm may sound and/or a message may be sent to a user, such as an email or text message to a smartphone.

The animal shed 8 comprises a door opening 29, via which the feed carriage 10 can enter and exit the animal shed 8. The door opening 29 is closable by means of a shed door which can preferably be opened automatically. In this exemplary embodiment, the animal shed 8 comprises a plurality of mutually separate accommodation areas 6a-6h for the keeping of different groups of animals 9. The animals 9 are divided into groups in dependence on, for example, the lactation stage and/or milk production, such as into groups of high-yielding and low-yielding animals 9. Each group of animals 9 is fed with a quantity of feed according to a recipe that is tailored to these animals 9. The recipe for some groups of animals 9 may be the same, and the recipe for one or more groups of animals 9 may also differ from the recipe for the other groups of animals 9.

In this exemplary embodiment, the animal shed 8 has two feeding alleys 30. It is of course possible for more or fewer feeding alleys to be provided. In this exemplary embodiment, each feeding alley 30 is delimited on both sides by a plurality of feed fences 31a-h. Each feed fence 31a-h delimits the accommodation area 6a-h for a group of animals 9. In other words, in this exemplary embodiment the animal shed 8 comprises eight feed fences 31a-h. Feed fences that extend in line with each other and are formed by a single fence construction in the animal shed 8, such as feed fences 31a and 31b or feed fences 31e and 31f, are defined as separate feed fences in the control system 35. The feed fences 31a-h each form a feeding place or feeding station for feeding the animals 9 in the accommodation area 6a-h behind that feed fence. The animals 9 can stand next to each other along the feed fence 31a-h. The animals 9 stand with their heads towards the feeding alley 30 and are able to put their heads through the feed fence 31a-h in order to eat feed that has been deposited along the feed fence 31a-h by the feed carriage 10.

The feed fences 31a-h in the animal shed 8 are situated at a distance from the feed loading station 16 of the feed kitchen 7. The feed carriage 10 is able to reach each feed fence 31a-h from the feed loading station 16. Various beacons are arranged in the operational area 2. In this exemplary embodiment, the beacons are formed by strips 32 which are disposed in or on a ground surface, walls 33 of the animal shed 8 and impact points 34. The feed carriage 10 comprises a sensor system (not illustrated) which is configured to cooperate with the beacons 32, 33, 34. The sensor system may also, for example, comprise an ultrasonic sensor or camera which is connected to the control unit 15 of the feed carriage 10, wherein the control unit 15 is configured to cause the feed carriage 10 to move along the feed fence 31a-h at a certain distance therefrom and substantially parallel thereto. In addition, in this exemplary embodiment the feed carriage 10 comprises a gyroscope (not illustrated) in order to travel straight ahead over a predetermined distance. The gyroscope is connected to the control unit 15 of the feed carriage 10.

The recipe data for each feed fence 31a-h are stored in the memory 35a of the control system 35, i.e. the recipe of mixed feed which will be deposited is recorded for each feed fence 31a-h. In addition to the recipe data, various other data are stored in the memory 35a of the control system 35, such as navigation data and operating data. The navigation data comprise beacon data of the beacons 32, 33, 34. On the basis of the navigation data, the feed carriage 10 is able to travel different routes from the feed loading station 16 to and through the animal shed 8. If there are a plurality of animal sheds (not shown), it is also possible for one or more routes to and/or through different animal sheds to be defined. The operating data comprise, for example, operating data for operating the dispensing device 14 of the feed carriage 10.

The feed carriage 10 comprises a feed-quantity measuring device 38 for measuring the quantity of feed that is located, for consumption by the animals 9, along the feed fences 31a-h along which the feed carriage 10 travels. The feed-quantity measuring device 38 comprises, for example, a laser which measures the feed height (h in mm) of the feed along the feed fences 31a-h. The quantity of feed at each feed fence 31a-h can be calculated on the basis of the measured feed height h. In this exemplary embodiment, the feed-quantity measuring device 38 is fitted to the feed carriage 10. The feed-quantity measuring device 38 measures the feed height h while the feed carriage 10 is travelling along each feed fence 31a-h. Each time the feed carriage 10 travels along the feed fences 31a-h, the feed-quantity measuring device 38 measures the associated feed height h.

In this exemplary embodiment, the feed carriage 10 comprises a feed pushing device for pushing feed in a direction transverse to the direction of travel of the feed carriage 10 (not shown), i.e. the feed pushing device pushes feed that lies along the feed fence 31a-h and that has been moved away from the feed fence 31a-h by the animals 9 whilst eating back towards that feed fence 31a-h. In so doing, the feed pushing device also moves the dispensed fresh feed. In other words, after the dispensing device 14 has dispensed the fresh feed, that fresh feed is immediately pushed, together with the feed still situated along the feed fence 31a-h.

The feed-quantity measuring device 38 is fitted to the feed carriage 10 in such a way that the feed just deposited by the dispensing device 14 is included in the measurement of the quantity of feed, i.e. the dispensing device 14 first meters the feed out of the container 12 in front of the feed fence 31 and directly thereafter the feed-quantity measuring device 38 measures the feed height at that feed fence 31. The measured feed height is dependent on the quantity of feed that was not yet eaten, i.e. feed dispensed at an earlier stage and pushed back towards the feed fence 31, and on the quantity of fresh metered-out feed at that feed fence 31.

The control system 35 is configured to receive the feed heights measured along the feed fences 31a-h. The feed heights are first temporarily stored in a memory of the control unit 15 of the feed carriage 10. After the feed carriage 10 has returned to the feed loading station 16, the measured feed heights are sent to the control system 35 and stored in the memory 35a of the control system 35. The control system 35 is programmed to calculate the quantity of feed that is available for consumption by the animals 9 at each feed fence 31a-h on the basis of the measured feed heights h.

However, the feed-quantity measuring device may also be configured differently. By way of example, the feed-quantity measuring device may comprise one or more cameras which take a camera image of the feed fences 31a-h. In this case, the control system 35 is configured to use the camera images as a basis to determine the quantity of feed that is available for consumption by the animals 9 at the feeding places 31a-h. It is also possible for a feed trough comprising one or more weight sensors to be arranged along each feed fence 31a-h. In this case, the weight sensors can measure the weight of the quantity of feed at each feed fence 31a-h.

The feeding system 1 according to the invention works in a demand-driven manner. The control system 35 uses a feeding criterion. In this exemplary embodiment, the feeding criterion comprises a threshold value for the quantity of available feed at the feed fences 31a-h. The threshold value is settable for each feed fence 31a-h separately. The control system 35 is configured to determine a feed requirement for each feed fence 31a-h by comparing the quantity of feed measured by the feed-quantity measuring device 38 at that feed fence 31a-h with the threshold value for the quantity of available feed.

In other words, for each feed fence 31a-h, the control system 35 determines whether the measured quantity of feed at that feed fence 31a-h has dropped below the threshold value for the quantity of available feed. If that is the case, that feed fence 31a-h has a feed requirement, i.e. a feed requirement of greater than 0.

The threshold value can, for example, be manually input into the control system 35 by the farmer, or be automatically generated by the control system 35. Preferably, this threshold value for the quantity of available feed is set in such a way that the feed carriage 10 dispenses feed at each feed fence 31a-h before the animals 9 have eaten the feed. The feeding criterion is such that in each case feed is provided before the feed at one of the feed fences 31a-h runs out. In other words, the feeding system 1 according to the invention normally ensures that feed is available at the feed fences 31a-h and the animals 9 are virtually always able to eat.

“Empty” should be understood to mean that the feed fences 31a-h are effectively empty, i.e. if there is still a residual quantity of feed that is essentially no longer suitable for consumption by the animals 9 or is in practice no longer eaten by the animals 9, the feed fence is “empty”. The feed is then “depleted”, even if there is still a low residual quantity of feed.

It is also possible for the feed requirement to be determined in other ways. By way of example, the control system 35 may be configured to store feed heights measured at different points in time by the feed-quantity measuring device 38 at the feed fences 31a-h as feed-quantity values in the memory 35a of the control system 35. The control system 35 may be programmed to use these stored feed-quantity values as a basis to calculate, i.e. predict, the progression of the feed-quantity values over time, in particular by means of a self-learning algorithm. The control system 35 may then determine a feed requirement of the feed fences 31a-h on the basis of the feeding criterion by using the calculated progression. By, for example, determining when the feed at the feeding places runs out and subsequently extrapolating how much time is required to prepare the feed in the container 12 of the feed carriage 10 and/or a stationary (pre-)mixer and how long it takes to bring the feed loaded into the container 12 to the feed fences 31a-h, the control system 35 can also in this way determine which feed fences 31a-h have a feed requirement.

In this case, it is also preferred that the animals are always able to eat. In other words, in this case the control system 35 may be configured to determine the feed requirement of the feed fences 31a-h in such a way that the feed carriage 10 dispenses feed at each feed fence 31a-h before the animals 9 have eaten the feed.

The control system 35 therefore determines, on the basis of the measured quantity of feed at the feed fences 31a-h and the feeding criterion, a feed requirement of each of the feed fences 31a-h. The feed requirement is dependent on time.

In this exemplary embodiment, for each feed fence 31a-h, a respective value for a quantity of feed to be dispensed is saved in the memory 35a of the control system 35, in particular a value in kg. This value for each individual feed fence 31a-h is, for example, manually input by the user. A value (in kg) for the desired quantity of feed to be dispensed is therefore added to each feed fence 31a-h. If a feed fence 31a-h has a feed requirement, the control system 35 retrieves the associated value for the quantity of feed to be dispensed.

By way of example, for the feeding system 1, the data specified below in Table 1 are stored in the memory 35a of the control system 35:

TABLE 1

| Feed | | | |
|---|---|---|---|
| fence | Recipe | Quantity (kg) | Threshold value (cm) |
| 31a | I | 125 | 12 |
| 31b | I | 150 | 10 |
| 31c | II | 250 | 10 |
| 31d | II | 100 | 8 |
| 31e | I | 120 | 10 |
| 31f | II | 200 | 5 |
| 31g | I | 50 | 5 |
| 31h | I | 300 | 14 |

In this Table 1, it is indicated that the animals 9 at the feed fences 31a, 31b, 31e, 31g and 31h are fed with mixed feed according to recipe I and the feed fences 31c, 31d and 31f are provided with mixed feed according to recipe II. The recipes I and II are stored in the memory 35a of the control system 35.

Let us now suppose that the feed carriage 10 travels a “scanning run”, i.e. a route along one or more of the feed fences to measure how much feed is still available for the animals 9. By way of example, the feed carriage 10 travels a route along all the feed fences in the animal shed 8 by first travelling clockwise along the feed fences 31a, 31b, 31h and 31g, then turning in the feeding alley 30 at the door opening 29, and subsequently travelling anticlockwise along the feed fences 31e, 31f, 31d and 31c. Here, the feed carriage 10 will push the remaining feed at the feed fences, and measure the feed height at each feed fence. In Table 2 below, there is an example of measured feed heights in combination with the stored data:

TABLE 2

| Feed | | Quantity | Threshold value | Feed height |
|---|---|---|---|---|
| fence | Recipe | (kg) | (cm) | (cm) |
| 31a | I | 125 | 12 | 7 |
| 31b | I | 150 | 10 | 4 |
| 31c | II | 250 | 10 | 9 |
| 31d | II | 100 | 8 | 11 |
| 31e | I | 120 | 10 | 6 |
| 31f | II | 200 | 5 | 10 |
| 31g | I | 50 | 5 | 2 |
| 31h | I | 300 | 14 | 6 |

The control system 35 is programmed to determine which feed fences have a feed requirement, i.e. a feed requirement greater than 0. These feed fences are eligible to be provided with feed. It is clear from Table 2 that a sufficient amount of feed is still present at the feed fences 31d and 31f, but the other feed fences 31a, 31b, 31c, 31e, 31g and 31h have a feed requirement. The feed height of the remaining feed has dropped below the threshold value at these latter feed fences.

The control system 35 is also configured to determine a priority of the feed fences with a feed requirement. In particular, the control system 35 is programmed to sort the feed fences with a feed requirement in an order of decreasing priority. In this exemplary embodiment, the control system 35 determines the feed fence at which the quantity of feed measured by the feed-quantity measuring device 38 has dropped furthest below the threshold value for the quantity of available food. The control system 35 selects that feed fence as the feed fence with the highest priority—this feed fence forms the first feed fence to be provided with feed. The control system 35 then determines the feed fence at which the difference between the threshold value and the measured feed height is then the greatest, and so on.

In this way, the control system 35 generates a first feeding task list of feeding tasks. Each feeding task consists of a quantity of feed to be dispensed for one of the feed fences. The feeding tasks are listed in the first feeding task list in particular in order of decreasing priority. A number of feeding tasks of the first feeding task list may be combined so as to be carried out by the feed carriage 10 with one batch of feed received in the container 12. The control system 35 uses the first feeding task list as a basis to generate a second, combined feeding task list containing feeding tasks to be carried out with one batch of feed received in the container 12. For this, the control system 35 follows the steps which are diagrammatically illustrated in the flow chart according to FIG. 2. The first feeding task list forms the starting point (step 100).

The control system then determines which recipe is required at the feed fence with the highest priority (step 101). It is clear from Table 2 that, in this example, the feed fence 31h is the feed fence with the greatest difference between the measured feed height and the associated threshold value, namely 8 cm. The feed fence 31h has the highest priority, and will be the first fence to be provided with feed. This feed fence 31h is associated with the recipe I. The control system 35 removes (also in step 101) the feeding tasks that relate to feed fences with a feed requirement for feed according to a different recipe from the first feeding task list. In this example, the feed fence 31c does have a feed requirement, but the animals 9 at this feed fence 31c are fed with feed according to recipe II, which differs from recipe I of the feed fence 31h with the highest priority. The feed fence 31c is therefore deleted from the first feeding task list, such that only the feed fences 31a, 31b, 31e and 31g remain.

The feeding tasks for the feed fences 31a, 31b, 31e and 31g with a feed requirement for recipe I are then sorted in order of decreasing priority, which is determined on the basis of the difference between the threshold value and the measured feed height, as indicated below in Table 3:

TABLE 3

| Feed | | | | |
|---|---|---|---|---|
| fence | Recipe | Quantity (kg) | Difference (cm) | Priority |
| 31h | I | 300 | 8 | 1 |
| 31b | I | 150 | 6 | 2 |
| 31a | I | 125 | 5 | 3 |
| 31e | I | 120 | 4 | 4 |
| 31g | I | 50 | 3 | 5 |

If, moreover, a plurality of routes are defined for the feed carriage 10, for example in the case of a feeding system comprising a plurality of animal sheds, feed fences that lie on a different route from the feed fence with the highest priority are also removed from the list (not shown). After step 101, the first feeding task list is refined, such that only feed fences with a requirement for recipe I are still included, wherein the priority to be provided with feed is added, as illustrated in Table 3.

The control system 35 is configured to then gradually generate the second, combined feeding task list (output of the flow chart in step 108) by assessing, for the feeding tasks of the first feeding task list in order of priority, whether these feeding tasks are transferred to the second, combined feeding task list. This will now be explained in more detail.

In step 102, the control system 35 repeatedly checks whether there is a feeding task on the first feeding task list. If this is the case, the control system 35 selects the feeding task with the highest priority (step 103). The control system 35 thus first determines a first feeding task consisting of feeding a first quantity of feed intended for the feed fence with the highest priority. In this example, the feed fence 31h has priority 1, and the control system determines the associated quantity of feed as first quantity of feed, i.e. the value of 300 kg is retrieved from the memory 35a of the control system 35. In other words, the first feeding task consists of feeding 300 kg according to recipe I to the feed fence 31h.

The control system 35 then checks whether the quantities of feed of feeding tasks on the second, combined feeding task list and the quantity of feed of the feeding task selected in step 103 added together are smaller than or equal to the threshold value for the maximum feed load of the container 12 (step 104). If so, the feeding task selected in step 103 is then added to the second, combined feeding task list, i.e. removed from the first feeding task list and transferred to the second, combined feeding task list (step 105). Since the second, combined feeding task list begins as an empty list, the control system 35 will always transfer the first feeding task with the highest priority from the first feeding task list to the second, combined feeding task list.

The control system 35 then returns to step 102 and determines whether there is then a further feeding task in the feeding task list. If so, the control system 35 then selects the feeding task with the highest priority (step 103). The control system 35 then calculates again whether the sum of the quantities of feed of feeding tasks in the second, combined feeding task list and the quantity of feed of this further feeding task selected in step 103 is smaller than or equal to the threshold value for the maximum feed load of the container 12 (step 104). If so, this further feeding task is then added to the second, combined feeding task list (step 105).

The maximum feed load of the container 12 is, for example, 600 kg. In this example, after the feed fence 31h, the feed fence 31b has the highest priority. In order to provide the second feed fence 31b with feed, it is established that 150 kg of feed is dispensed at this feed fence 31b. The sum of the first quantity of feed for the first feed fence 31h and the second quantity of feed for the second feed fence 31b (300 kg+150 kg=450 kg) is smaller than the maximum feed load. The second feeding task of feeding 150 kg according to recipe I to the feed fence 31b is added to the second, combined feeding task list.

Steps 102, 103, 104 and 105 are repeated. In this example, the feed fence 31a is then the feed fence with the highest priority. The associated quantity of feed (125 kg) can also be added to the quantities of feed of the first and second feeding task which are already on the second, combined feeding task list (450 kg+125 kg=575 kg). The third feeding task of feeding 125 kg according to recipe I to the feed fence 31a is also added to the second, combined feeding task list.

In other words, the control system 35 analyses, in order of priority of the feed fences, on the basis of the values (kg) recorded in the memory 35a for the associated quantities of feed, whether one or more further quantities of feed can be added to the first quantity of feed (in this example 300 kg) without the threshold value for the maximum feed load of the container 12 being exceeded. The control system 35 adds as many further quantities of feed as possible to the first quantity of feed.

The control system 35 then once again attempts to combine a quantity of feed. However, the quantity of feed for the feed fence 31e with priority 4 (120 kg) can no longer be added to the container 12—the container 12 would then overflow. According to the invention, the control system 35 then analyses whether, after performing the feeding tasks that are already on the second, combined feeding task list, in a subsequent feeding run only one small feeding task remains or only a plurality of feeding tasks that collectively are still small remain. If only one small quantity of feed remains for the subsequent feeding run, there is the risk that the capacity of the feed carriage 10 is not optimally utilized and the mixed feed deviates from the prescribed recipe. The control system 35 according to the invention is configured to prevent small batches of feed.

Once it is no longer possible to add the quantity of feed of the feeding task selected in step 103 without the maximum feed load being exceeded, the control system 35 calculates, in step 106, a first sum S1 of the quantities of feed of all the feeding tasks on the first feeding task list. The control system 35 checks whether this sum minus an overload value O, which is equal to the maximum feed load and a limit value for a small quantity of feed added together, is greater than this limit value or is smaller than 0. In this exemplary embodiment, this limit value is 30% of the maximum feed load, i.e. 30%*600=180 kg. The overload value is then 600 kg+180 kg=780 kg (130%). In this example, the sum of the quantities of feed of all the feeding tasks collectively in the first feeding task list, i.e. the feeding tasks with the priorities 1, 2, 3, 4 and 5, is 300 kg+150 kg+125 kg+120 kg+50 kg=745 kg. This sum minus the overload value of 780 kg (S1-O) is smaller than 0. In other words, the feeding tasks with the priorities 4 and 5 form “small” feeding tasks, which in a subsequent feeding run possibly result in an inaccurate feed composition and low utilization of the capacity of the feeding system. In order to prevent such small feeding tasks, the control system 35 will proceed with step 109 to check whether the feeding tasks with the priorities 4 and 5 actually also fit in the container 12 of the feed carriage 10. Step 109 will be described in more detail below.

But first: let us suppose that the quantity of feed for the feed fence 31e with priority 4 was 200 kg instead of 120 kg. In this case, the first sum S1 of the quantities of feed of all the feeding tasks in the first feeding task list is: 300 kg+150 kg+125 kg+200 kg+50 kg=825 kg. This sum minus the overload value of 780 kg (S1−O=45 kg) lies between 0 and the limit value of 180 kg, i.e. the sum minus the overload value (S1−O) is not greater than this limit value and is not smaller than 0. The control system 35 is configured to in this case proceed with step 107, in which the feeding task selected in step 103, in this example the feeding task with priority 4, is deleted from the first feeding task list without being added to the second, combined feeding task list. The control system 35 then returns to step 102.

In steps 102 and 103, the control system 35 then selects the feeding task with priority 5 (50 kg for feed fence 31g). The quantity of feed for feed fence 31g is also too great to be added to the quantities of feed collectively of the feeding tasks already added to the second, combined feeding task list—the container 12 would then overflow. The control system 35 therefore ends up at step 106 again. Since in that case nothing changes in the calculation of the first sum S1 of the quantities of feed of all the feeding tasks in the first feeding task list minus the overload value, S1-O=45 kg remains the same, the control system 35 proceeds with step 107, in which the feeding task selected in step 103, now the feeding task with priority 5, is deleted from the first feeding task list without being added to the second, combined feeding task list. The control system 35 then returns again to step 102. There are then no more feeding tasks on the first feeding task list, and thus the control system 35 terminates with step 108.

The second, combined feeding task list is then ready to be carried out by the feeding system 1. The container 12 is loaded with a 575 kg batch of feed, and the feed carriage 10 performs the feeding tasks with priorities 1, 2 and 3, i.e. meters 300 kg at feed fence 31h, 150 kg at feed fence 31b and 125 kg at feed fence 31a. The feeding tasks with priorities 4 and 5 are left for a subsequent feeding run. However, these feeding tasks are collectively not small (200 kg+50 kg=250 kg), and therefore it is ensured that the batch of feed for the subsequent feeding run is large enough to efficiently utilize the capacity of the feeding system 1 and accurately follow the prescribed recipe.

Now returning to the example in which the quantity of feed for the feed fence 31e with priority 4 is 120 kg (see Table 3). As described above, the feeding system according to the invention is configured to prevent small feeding tasks. The control system 35 is programmed to, after step 104, if the feeding task selected in step 103 cannot be added without the maximum feed load being exceeded, analyse, in step 106, whether a small feeding task remains in the first feeding task list or a plurality of feeding tasks that collectively are still small remain in the first feeding task list. If that is the case, the control system 35 proceeds with step 109, in which the control system 35 checks whether the feeding tasks with the priorities 4 and 5 actually also fit in the container 12 of the feed carriage 10.

In step 109, the control system 35 calculates a second sum S2 of the quantities of feed of the feeding tasks that have already been added to the second, combined feeding task list and an additional quantity of feed of the feeding task selected in step 103. In this example, the second sum S2 of the quantities of feed of the first and further feeding tasks already on the second, combined feeding task list (575 kg) and the feeding task selected in step 103 (feeding task with priority 4 of 120 kg for feed fence 31e) is: 695 kg. The control system 35 compares this second sum S2 with the overload value O, in this exemplary embodiment 780 kg (130%). In the event that the second sum S2 is smaller than the overload value O, the feeding task selected in step 103 will then be added to the second, combined feeding task list.

However, since this feeding task selected in step 103 actually does not fit in the container 12, the control system 35 first reduces, in step 110, the first quantity of feed and/or the one or more further quantities of feed and/or the small additional quantity of feed in such a way that the sum of the quantities of feed is smaller than or equal to the maximum feed load. In other words, the quantities of feed of the feeding tasks of the second, combined feeding task list are reduced in such a way that the container 12 does not overflow. And, in step 105, the control system 35 then adds the small additional feeding task selected in step 103 to the second, combined feeding task list.

In this example, the control system 35 determines that the small quantity of feed for the feed fence 31e in the feeding task list (priority 4, 120 kg) can be added to the quantities of feed of the already established feeding tasks in the second, combined feeding task list without 130% of the maximum feed load (780 kg) being exceeded, because the sum 575 kg+120 kg=695 kg is smaller. And, in this exemplary embodiment, the quantities of feed of all the feeding tasks in the second, combined feeding task list are then reduced uniformly by the control system 35 (step 110), in this example by 600/695=86.3%. This means that, in the combined feeding task list, the first quantity for the feed fence 31h is reduced to 300*86.3%=259 kg, the second quantity for the feed fence 31b is reduced to 150*86.3%=129 kg, and the third quantity for the feed fence 31a is reduced to 125*86.3%=108 kg. The small additional quantity for the feed fence 31e is also reduced to 120*86.3%=104 kg. This small additional quantity for the feed fence 31e is then added as an additional feeding task to the second, combined feeding task list and deleted from the first feeding task list (step 105).

After that, the control system 35 determines in step 102 that there is still a feeding task in the first feeding task list, i.e. the small quantity of feed of 50 kg for the feed fence 31g (priority 5). The control system 35 runs through steps 103, 104, 105 and 106 again and then returns to step 109 again. In step 109, the control system 35 once again calculates the second sum S2 of the non-reduced quantities of feed, stored in the memory, of the feeding tasks already on the second, combined feeding task list and the additional quantity of feed of the small additional feeding task for the feed fence 31g: 300 kg+150 kg+125 kg+120 kg+50 kg=745 kg. The control system 35 again compares this second sum S2 with the overload value O (780 kg or 130% of the maximum feed load). Since this second sum S2 is also smaller than the overload value O, the control system 35 will again reduce, in step 110, the quantities of feed of the feeding tasks of the second, combined feeding task list in such a way that the container 12 does not overflow.

In this exemplary embodiment, in step 110 the originally stored, non-reduced quantities of feed of all the feeding tasks in the second, combined feeding task list and of the small additional feeding task now selected in step 103 (priority) are then reduced uniformly by the control system 35, in this example by 600/745=80.5%. This means that the first quantity for the feed fence 31h is reduced to 300*80.5%=241 kg, the second quantity for the feed fence 31b is reduced to 150*80.5%=121 kg, and the third quantity for the feed fence 31a is reduced to 125*80.5%=101 kg. The small additional quantity of feed for the feed fence 31e was also added to the second, combined feeding task list and is also reduced to 120*80.5%=97 kg. And the small additional quantity of feed for the feed fence 31e is now also reduced to 50*80.5%=40 kg. In step 105, this small additional quantity of feed for the feed fence 31g is then also added as an additional feeding task to the second, combined feeding task list and deleted from the first feeding task list. After that, the control system 35 returns to step 102 again.

Since the first feeding task list is then empty, the control system 35 terminates with step 108. The second, combined feeding task list is then ready to be carried out by the feeding system 1. On the basis of the second, combined feeding task list, the container 12 of the feed carriage 10 is loaded with feed, and the feed carriage 10 meters the quantities of feed according to the second, combined feeding task list at the relevant feed fences, i.e. the reduced quantities of feed specified above at the feed fences 31h, 31b, 31a, 31e and 31g.

Let us now suppose that the quantity of feed for the feed fence 31e with priority 4 is still 120 g, and the quantity of feed for the feed fence 31g with priority 5 was 300 kg instead of 50 kg. In this case, in step 106 the first sum S1 of the quantities of feed of all the feeding tasks in the first feeding task list is: 300 kg+150 kg+125 kg+120 kg+300 kg=995 kg. This sum minus the overload value of 780 kg (S1−O=215 kg) is greater than the limit value of 180 kg (30%). In this case, the control system 35 thus also proceeds with step 109. Just as described above, when running through the steps for the feeding task with priority, the control system 35 will reduce the quantities of feed and will add the feeding task with priority 4 as an additional feeding task to the second, combined feeding task list. If the control system then selects the feeding task with priority 5 in step 103, the control system again runs through steps 104 and 106 and again ends up at step 109.

However, the second sum S2 of the non-reduced quantities of feed, stored in the memory, of the feeding tasks already on the second, combined feeding task list (300 kg+150 kg+125 kg+120 kg=695 kg) and the feeding task now selected in step 103 (feeding task with priority 5 of 300 kg for feed fence 31e) is now collectively 995 kg. Since this second sum S2 is not smaller than the overload value O (780 kg), the control system 35 will now proceed from step 109 to step 107, i.e. the quantity of feed of the feeding task with priority 5 (300 kg) is not added to the second, combined feeding task list and is deleted from the first feeding task list. The control system 35 then returns to step 102.

Since the first feeding task list is then empty, the control system 35 then also terminates with step 108. The second, combined feeding task list is ready to be carried out by the feeding system 1. On the basis of the second, combined feeding task list, the container 12 of the feed carriage 10 is loaded with feed, and the feed carriage 10 meters the quantities of feed according to the second, combined feeding task list at the relevant feed fences, i.e. the reduced quantities of feed specified above at the feed fences 31h, 31b, 31a and 31e.

In this way, it no longer or hardly happens in practice that small feeding tasks remain for a subsequent feeding run. This means that the capacity of the container is better utilized. Since small batches of feed are prevented, the quantities (kg) of the different ingredients can also be loaded more accurately according to the prescribed recipe, and the differences between the prescribed recipe and the mixed feed that is actually dispensed are minimal.

It is noted that the feeding system described above is also suitable for dispensing mixed feed according to the same recipe at all the feed fences 31a-h. In addition, this feeding system can feed different non-mixed feed types at different feed fences, for example grass silage at a first group of feed fences and corn at another group of feed fences.

The invention is not restricted to the exemplary embodiment illustrated in the figures. The person skilled in the art can come up with various modifications which are within the scope of the invention.

1. A feeding system for feeding animals including dairy cows or beef cows, at a plurality of feeding places, wherein the feeding system comprises:
at least one feeding device with a container for receiving a batch of feed, which container has a maximum feed load, and which feeding device is configured to move autonomously to the feeding places in order to bring feed received in the container to the feeding places and dispense it there,
a feed-quantity measuring device for measuring the quantity of feed that is available for consumption by the animals at the feeding places, and
a control system which is configured to provide a combined feeding task list of one or more feeding tasks to be carried out by the feeding device with a batch of feed received in the container, wherein each feeding task comprises a quantity of feed to be dispensed for one of the feeding places, and wherein this provision of the combined feeding task list comprises:
determining which feeding places have a feed requirement on the basis of a feeding criterion and the quantity of feed measured by the feed-quantity measuring device at the feeding places,
selecting a first feeding place from the feeding places with a feed requirement,
determining a first feeding task comprising a first quantity of feed determined for the first feeding place, and adding the first feeding task to the combined feeding task list,
determining one or more further feeding tasks each comprising a further quantity of feed determined for a further feeding place selected from the feeding places with a feed requirement, and adding the one or more further feeding tasks to the combined feeding task list if these one or more further quantities of feed are able to be added to the first quantity of feed without the maximum feed load of the container being exceeded,
determining at least one additional feeding task comprising an additional quantity of feed determined for an additional feeding place selected from the feeding places with a feed requirement, wherein this additional quantity of feed added to the first and one or more further quantities of feed of the feeding tasks on the combined feeding task list exceeds the maximum feed load of the container, and adding this additional feeding task to the combined feeding task list if
a first sum of the quantities of feed which are determined for all the feeding places with a feed requirement minus an overload value, which is equal to the maximum feed load and a limit value for a small quantity of feed added together, is greater than this limit value or is smaller than 0, and
a second sum of the first and one or more further quantities of feed of the feeding tasks on the combined feeding task list and this additional quantity of feed is smaller than this overload value,
wherein, in the event that this additional feeding task is added to the combined feeding task list, the control system reduces at least one of the first quantity of feed, the one or more further quantities of feed and this additional quantity of feed in such a way that a reduced sum of the first quantity of feed, the one or more further quantities of feed and this additional quantity of feed is smaller than or equal to the maximum feed load.

2. The feeding system according to claim 1, wherein the additional feeding task is not added to the combined feeding task list if the first sum of the quantities of feed which are determined for all the feeding places with a feed requirement minus the overload value is smaller than the limit value and is greater than 0.

3. The feeding system according to claim 1, wherein the additional feeding task is not added to the combined feeding task list if the second sum of the first and one or more further quantities of feed of the feeding tasks on the combined feeding task list and this additional quantity of feed is greater than the overload value.

4. The feeding system according to claim 1, wherein the predetermined limit value is settable, in particular can be input into the control system by a user.

5. The feeding system according to claim 1, wherein the predetermined limit value is selected on the basis of the maximum feed load of the container, and wherein the predetermined limit value preferably lies between 10% and 50% of the maximum feed load of the container, in particular between 20% and 40%.

6. The feeding system according to claim 1, wherein the control system comprises a memory in which different recipes for mixed feed are stored, wherein each recipe comprises one or more ingredients in a predetermined ratio, and wherein the control system is configured to determine, for at least each feeding place with a feed requirement, the associated recipe for mixed feed, wherein the control system is configured to, after selecting the first feeding place with a feed requirement for mixed feed according to a first recipe and determining the first feeding task for the first feeding place, when determining the further and additional feeding tasks, only select feeding places with a feed requirement for mixed feed according to the same first recipe.

7. The feeding system according to claim 1, wherein, for each feeding place, a respective value for a quantity of feed to be dispensed is stored in the control system, in particular can be input into the control system by a user, and wherein the control system is configured to, when determining the feeding tasks, determine the quantities of feed for the feeding places on the basis of the stored values.

8. The feeding system according to claim 1, wherein the maximum feed load of the container is settable, in particular can be input into the control system by a user.

9. The feeding system according to claim 1, wherein the feeding criterion comprises a threshold value for the quantity of available feed at the feeding places, and wherein the control system is configured to determine the feed requirement of the feeding places by comparing the quantity of feed measured by the feed-quantity measuring device at the feeding places with this threshold value for the quantity of available feed, wherein in particular this threshold value for the quantity of available feed is set in such a way that the feeding device dispenses feed at each feeding place before the animals have eaten the feed at this feeding place.

10. The feeding system according to claim 1, wherein the control system is configured to determine which feeding place with a feed requirement has the highest priority, and to select this feeding place as the first feeding place.

11. The feeding system according to claim 10, wherein the control system is configured to determine a priority for each feeding place with a feed requirement, and to determine the one or more further feeding tasks and/or the one or more additional feeding tasks in order of decreasing priority of the feeding places with a feed requirement.

12. The feeding system according to claim 1, wherein the feed-quantity measuring device is fitted to the feeding device, and wherein the feed-quantity measuring device is configured to measure the quantity of feed that is available for consumption by the animals at the feeding places as the feeding device moves along these feeding places.

13. The feeding system according to claim 1, wherein the autonomous feeding device comprises a self-propelled carriage with wheels.

14. In combination, an animal shed for keeping animals including dairy cows or beef cows, and the feeding system according to claim 1.

15. A method for feeding animals including dairy cows or beef cows, at a plurality of feeding places with feed from a feed supply, wherein use is made of the feeding system according to claim 1.

16. The feeding system according to claim 2, wherein the additional feeding task is not added to the combined feeding task list if the second sum of the first and one or more further quantities of feed of the feeding tasks on the combined feeding task list and this additional quantity of feed is greater than the overload value.

17. The feeding system according to claim 2, wherein the predetermined limit value is settable, in particular can be input into the control system by a user.

18. The feeding system according to claim 3, wherein the predetermined limit value is settable, in particular can be input into the control system by a user.

19. The feeding system according to claim 2, wherein the predetermined limit value is selected on the basis of the maximum feed load of the container, and wherein the predetermined limit value preferably lies between 10% and 50% of the maximum feed load of the container, in particular between 20% and 40%.

20. The feeding system according to claim 3, wherein the predetermined limit value is selected on the basis of the maximum feed load of the container, and wherein the predetermined limit value preferably lies between 10% and 50% of the maximum feed load of the container, in particular between 20% and 40%.
